(19) United States
(12) Patent Application Publication
(10) Pub. No.: US 2013/0171961 A1
(43) Pub. Date: Jul. 4, 2013

(54) COMMUNICATION CONTROL SYSTEM AND METHOD

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/421,883

(22) Filed: Mar. 16, 2012

(30) Foreign Application Priority Data
Dec. 28, 2011 (CN) 201110447658.3

(51) Int. Cl. H04W 4/00

(52) U.S. Cl. 455/406

(57) ABSTRACT

A communication control system includes an interface providing network communication and receiving inputs from a user by a portable device; a non-transitory memory storing user information and a preset extension of time; a time unit starting to measure time when prepaid communication fee of the portable device starts to be consumed up; a credit verifying unit, determining if a further prepayment for the portable device has been paid when the extension of time is expired; and a control unit, keeping communication functions of the portable device on for the extension of time when the prepaid communication fee of the portable device starts to be consumed up, and cutting off the communication function of the portable device when the extension of time is expired and the further prepayment for the portable device has not been paid. A communication control method is also provided.

### BACKGROUND

1. Technical Field

The present disclosure relates to a communication control system and a method for communication control, and more particularly, to a communication control system and a method capable of changing communications functions of a portable device.

2. Description of Related Art

Under certain telecommunications plan, communication of a mobile phone with the network will be cut off when prepaid communication fee of the mobile phone has been consumed up. If the user does not renew the communication fee (i.e., make another prepayment) in time, and has important calls to make or other things to do using the mobile phone, a great deal of inconvenience will be caused.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of one embodiment of a communication control system in accordance with the present disclosure.

FIG. 2 is a flowchart of a method for controlling communication functions of a portable device by the communication control system in FIG. 1, in accordance with an embodiment.

### DETAILED DESCRIPTION

Embodiments of the present disclosure are described with reference to the accompanying drawings.

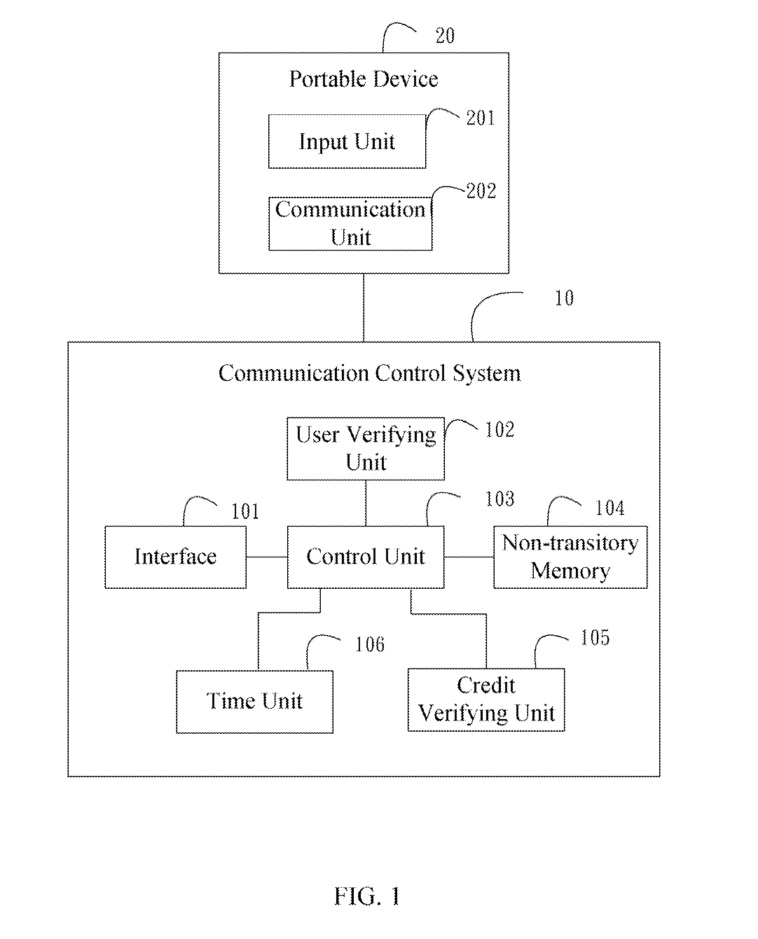

FIG. 1 is a block diagram of one embodiment of a communication control system 10 in accordance with the present disclosure. The communication control system 10 can be run on a server. The communication control system 10 is connected with a portable device 20 via a network. The portable device 20 includes an input unit 201 and a communication unit 202. The input unit 201 is used to receive input from users. The communication unit 202 is used to provide network communication to send and receive information.

The communication control system 10 receives information via the communication unit 202, keeps the communication function of the portable device 20 on for an extension of time when prepaid communication fee of the portable device 20 is consumed up, and cuts off the communication function of the portable device 20 when that extension of time is expired and a further prepayment has not been paid. The communication functions include call function, Internet function and/or SMS function.

The communication control system 10 includes an interface 101, a user verifying unit 102, a control unit 103, a non-transitory memory 104, a credit verifying unit 105, and a time unit 106.

The interface 101 is used to provide network communication and receive information from the communication unit 202. The memory 104 is used to store user information and a preset extension of time. The user information includes real user name of the user or an SN code or a PIN code relating to the portable device 20. The user verifying unit 102 compares the inputs from the user with the user information stored in the memory 104 to verify if the user is authentic. The time unit 106 starts to measure time when the prepaid communication fee of the portable device 20 is consumed up. The credit verifying unit 105 is used to determine if the further prepayment for the portable device 20 has been paid when the extension of time is expired.

The control unit 103 is used to keep the communication function of the portable device 20 on for the extension time when the prepaid communication fee of the portable device 20 starts to be consumed up, and cut off the communication function of the portable device 20 when the extension of time is expired and the further prepayment for the portable device 20 has not been paid.

The control unit 103 is further used to keep the communication function of the portable device 20 on for the extension of time when the prepaid communication fee of the portable device 20 starts to be consumed up and the user is authentic, and cuts off the communication function of the portable device 20 when the prepaid communication fee of the portable device 20 starts to be consumed up and the user is not authentic.

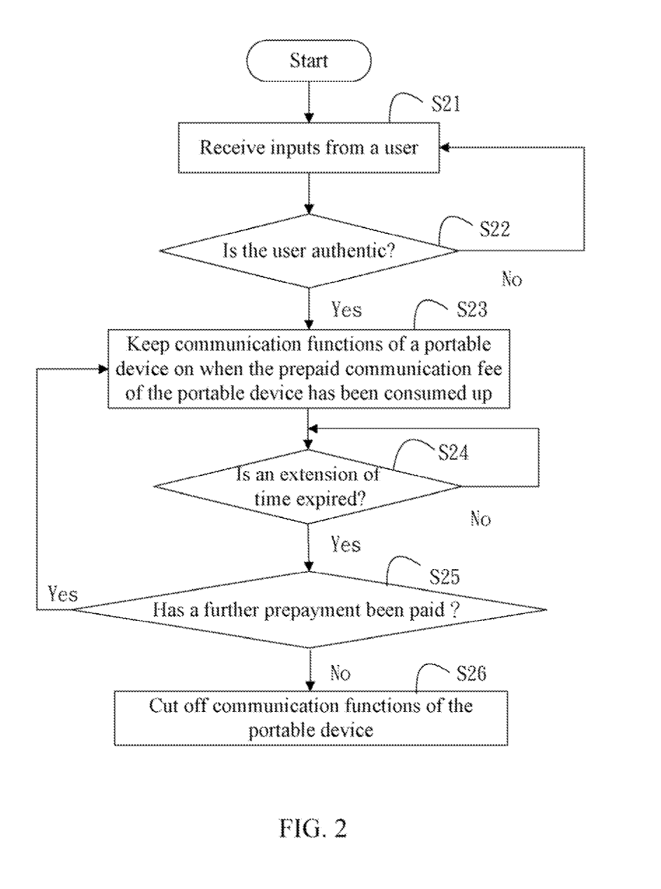

FIG. 2 is a flowchart of a method for controlling communication function of the portable device 20 by the communication control system 10 in FIG. 1, in accordance with an embodiment.

In step S21, the interface 101 provides network communication and receives inputs from the communication unit 202.

In step S22, the user verifying unit 102 compares the inputs from the user with user information stored in the memory 104 to verify if the user is authentic; if yes, the procedure goes to step S23, if no, the procedure goes back to step S21. The step may be implemented to repeat a preset number of times, for example, three.

In step S23, the control unit 103 keeps the communication function of the portable device 20 on when the prepaid communication fee of the portable device 20 has been consumed up.

In step S24, the time unit 106 starts to measure time when the prepaid communication fee of the portable device 20 has been consumed up, and determines if that extension of time is expired; if yes, the procedure goes to step S25, if no, the procedure repeats step S24.

In step S25, the credit verifying unit 105 determines if the further prepayment has been paid; if yes, the procedure goes to step S23, if no, the procedure repeats step S26.

In step S26, the control unit 103 cuts off the communication function of the portable device 20.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A communication control system comprising:
an interface, providing network communication and receiving inputs from a user by a portable device;
a non-transitory memory, storing user information and a preset extension of time;
a time unit, starting to measure time when prepaid communication fee of the portable device has been consumed up;
a credit verifying unit, determining if a further prepayment for the portable device has been paid when the extension of time is expired; and
a control unit, keeping communication functions of the portable device on for the extension of time when the prepaid communication fee of the portable device starts to be consumed up, and cutting off the communication function of the portable device when the extension of time is expired and the further prepayment for the portable device has not been paid.

2. The communication control system of claim 1, wherein the memory is further configured to store user information, the communication control system further comprises a user verifying unit for comparing inputs with the user information stored to verify if the user is authentic, and the control unit is further configured to keep the communication functions of the portable device on for the extension of time when the prepaid communication fee of the portable device starts to be consumed up and the user is authentic, and cut off the communication functions of the portable device when the prepaid communication fee of the portable device starts to be consumed up and the user is not authentic.

3. The communication control system of claim 1, wherein the communication control system is run on a server.

4. The communication control system of claim 1, wherein the user information comprises real user name of the user or an SN code or a PIN code relating to the portable device.

5. The communication control system of claim 1, wherein the communication functions comprise call function, Internet function and/or SMS function.

6. The communication control system of claim 1, wherein the portable device is connected with the communication control system via network.

7. A communication control method comprising:
starting to measure time when prepaid communication fee of a portable device has been consumed up;
determining if the extension of time is expired;
determining if a further prepayment for the portable device has been paid when the extension of time is expired; and
cutting off communication functions of the portable device when the further prepayment for the portable device has not been paid.

8. The communication control method of claim 7, wherein the method further comprises steps:
receiving inputs from a user by the portable device;
comparing the input information with user information stored in a memory to verify if the user is authentic; and
keeping the communication functions of the portable device on when the user is authentic and the portable device starts to be overdue, and cutting off the communication functions of the portable device when the user is not authentic and the prepaid communication fee of the portable device starts to be consumed up.

9. The communication control method of claim 8, wherein the method repeats the steps of receiving inputs from the portable device and comparing the inputs with user information stored in a memory to verify if the user is authentic for a preset number of times.

10. The communication control method of claim 9, wherein the preset number of times is 3.

11. The communication control method of claim 7, wherein the user information comprises real user name of the user or an SN code or a PIN code relating to the portable device.

12. The communication control method of claim 7, wherein the communication functions comprise call function, Internet function and/or SMS function.

13. The communication control method of claim 7, wherein the method further comprises step of providing network communication between the portable device and a communication control system using the communication control method.
